(19) United States
(12) Patent Application Publication
(10) Pub. No.: US 2013/0317891 A1
(43) Pub. Date: Nov. 28, 2013

(54) CONTENT RATING AND WEIGHTING SYSTEM

(71) Applicants: Vitaliy Grigorash, Arkhangelsk Region (RU); Vsevolod Kuznetsov, Sankt-Petersburg (RU)

(72) Inventors: Vitaliy Grigorash, Arkhangelsk Region (RU); Vsevolod Kuznetsov, Sankt-Petersburg (RU)

(73) Assignee: RAWLLIN INTERNATIONAL INC.

(21) Appl. No.: 13/480,008

(22) Filed: May 24, 2012

(51) Int. Cl. G07C 13/00

(52) U.S. Cl. 705/12

(57) ABSTRACT

Technologies are generally described for systems and methods effective to provide a content rating system to modify and weight ratings of online content. The content rating system can collect votes and ratings for online content received at a content rating portal, calculate the overall rating, and then weight the rating based on the number of votes collected. The ratings can be weighted downwards to compensate for the less statistically significant ratings. Once the number of votes collected passes a predetermined threshold, the ratings cease to be weighted. The ratings can also receive a confidence score that indicate a reliability or usefulness of the rating. The confidence score can be based on the items being voted on, and the voting history, among other factors.

### TECHNICAL FIELD

The subject disclosure relates generally to online content rating and weighting of the content ratings.

### BACKGROUND

As commerce increasingly goes online, personal interaction with salespeople, vendors, and others that facilitate the sale and rental of goods and services is becoming more limited. Consumers desiring to know about the benefits and drawbacks of online content are dependent on reviews and ratings left behind by people who may be anonymous or at least unknown to the consumers. While the overall rating of the online content can occasionally be helpful, often the reviews and ratings can be misleading or ambiguous.

When the overall rating is made up of only a few discrete votes or ratings, the overall rating can have a large margin of error rendering the rating virtually useless. Similarly, when the overall rating is based on ratings from individuals with divergent backgrounds and interests than the person viewing the rating, the overall rating can be misleading. The information required to determine the confidence of a rating is often unavailable, or not easily accessible to the people viewing the ratings.

### SUMMARY

Various non-limiting embodiments provide for online content rating and weighting. In an example embodiment, a system comprises a memory storing computer-executable components and a processor communicatively coupled to the memory that executes or facilitates execution of one or more of the computer executable components. The executable components can include a vote gathering component configured to collect votes, and a rating component configured to generate a rating based on the votes collected. The executable components can also include a weighting component configured to generate a weighting coefficient that modifies the rating as a function of a difference between a number of votes collected and a threshold number of votes.

In another example embodiment, a method comprises collecting, by a system including at least one processor, votes for an item. The method also comprises generating, by the system, a rating of the item based on the votes collected, and the method further comprises weighting, by the system, the rating using a weighting coefficient that modifies the rating as a function of a difference between a number of votes collected and a threshold number of votes.

In another example embodiment, a computer readable storage device has computer executable instructions that, in response to execution, cause a computing system to perform operations comprising collecting votes for an item, generating a rating of the item based on the votes collected, and weighting the rating using a weighting coefficient that modifies the rating as a function of a difference between a number of votes collected and a predetermined number of votes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example, non-limiting embodiment of a system for weighting content ratings;

FIG. 2 is a block diagram illustrating an example, non-limiting embodiment of a system for rating and weighting online content;

FIG. 3 is a block diagram illustrating an example, non-limiting embodiment of a system for providing a confidence score for rated items;

FIG. 4 is a block diagram illustrating an example, non-limiting embodiment of a system for scoring rated items;

FIG. 5 is a block diagram illustrating an example, non-limiting embodiment of a system for scoring rated items;

FIG. 6 illustrates a flow diagram of an example, non-limiting embodiment of a method for rating and weighting online content;

FIG. 7 illustrates a flow diagram of an example, non-limiting embodiment of a method for providing a confidence score for rated items;

FIG. 8 illustrates a flow diagram of an example, non-limiting embodiment of a method for weighting ratings that do not meet a threshold number of votes;

FIG. 9 illustrates a block diagram of an example electronic computing environment that can be implemented in conjunction with one or more aspects.

FIG. 10 illustrates a block diagram of an example data communication network that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, an content rating system is provided to modify and weight ratings of online content. The online content can be products, goods, and services for sale or rent. The online content can also be reviews of books, movies, hotels, and other items that may not be related to e-commerce. The content rating system can collect votes and ratings for online content received at a content rating portal. The content rating system can also collect vote and ratings from public and/or existing sources. For instance, the content rating system can scour many portals, websites, and databases to collect ratings and rankings of the online content, as well as information about the number of votes that make up the ratings and rankings.

When the ratings are collected, the content rating system can generate overall ratings for online content based on the collected votes, and modify and/or weight the generated overall ratings based on the number of votes the ratings consist of. For instance, if two items each have an equivalent rating, but the first item has been voted on over a thousand times, and the second item has only been voted on only ten times, the rating of the second item can be reduced to reflect the lower quality of the rating. Since the rating with only ten votes will have a much larger margin of error, weighting coefficient can be used to weight the rating downward.

The weighting coefficient can be a multiplier that can be between 0 and 1 and the weighted ranking can be the product of the weighting coefficient and the overall rating. The weighting coefficient can be a function of the number of votes, and can approach 1 as the votes approach a threshold number of votes.

In other embodiments, the content rating system can give an estimate of the level of confidence in the ratings of the online content. The confidence levels can be based on the number of votes, the identity and background of the people voting, content being voted on, background and context of the person viewing the ratings, and other information that can be used to generate a confidence score.

In another embodiment, the individual ratings and votes used to generate the average rating can also be filtered. For example, a user viewing the rating of the product can have similar or divergent preferences and interests with users placing the votes. The votes can be filtered based on the preferences and interests and votes of people with similar preferences and interests can be taken into account to improve the quality and confidence level of the ratings, while the votes of those with different interests can be ignored.

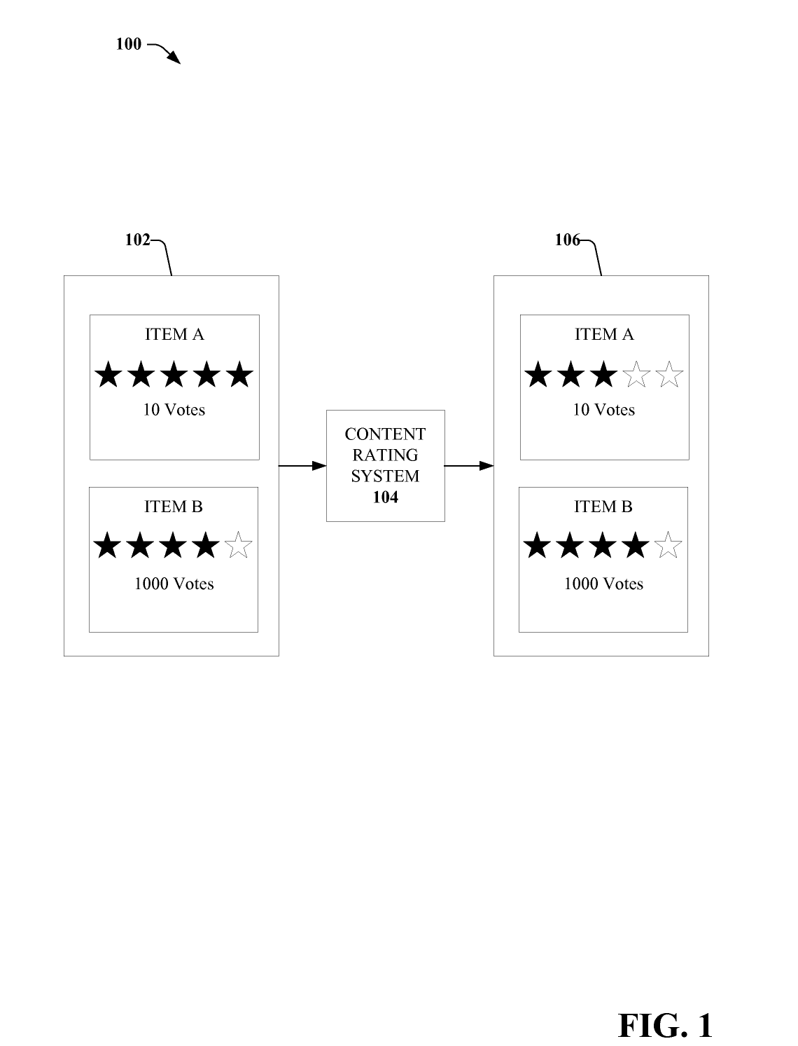

Referring now to FIG. 1, a block diagram illustrating an example, non-limiting embodiment of a system 100 for weighting content ratings is shown. Content rating system 104 collects the ratings 102 of items A and B, and weights the ratings to generate weighted ratings 106. The unweighted rating of item A, shown in 102, is 5/5 stars and the unweighted rating of item B is 4/5 stars. After content rating system 104 weights the ratings, item A is rated at 3/5 stars and item B is still rated at 4/5 stars as shown at 106.

It is to be appreciated that the specific ratings and the number of votes for items A and B in 102 and 106 are exemplary and are provided to show how content rating system 104 can modify and/or weight the ratings based on the number of votes. Other combinations of ratings and number of votes are possible in other scenarios and examples.

Content rating system 104 can weight the ratings of items A and B based on the number of votes that the ratings are made up of. Since item A has only 10 votes, far fewer than item B with 1000 votes, the high rating of item A is not as statistically significant as the rating of item B. Accordingly, content rating system 104 can weight the rating to reflect the statistical importance, and give it 3/5 stars as seen in 106. Since item B has 1000 votes however, the rating of 4/5 stars in 102 is statistically more significant, and so the content rating system 104 can weight the rating of item B very little or not at all.

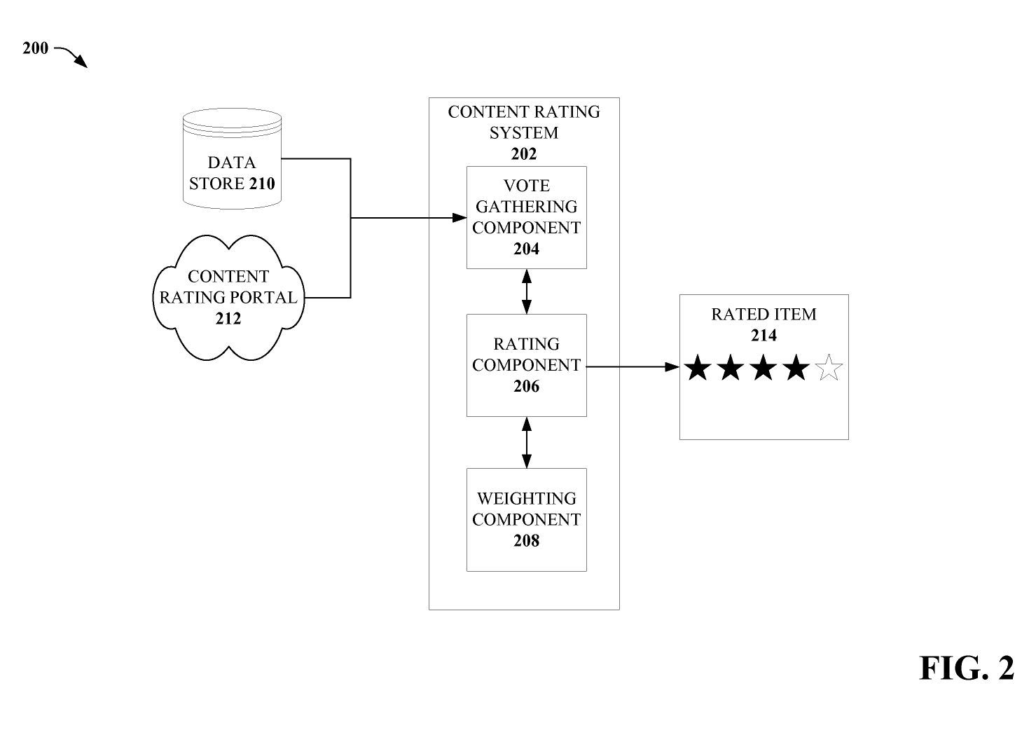

Turning now to FIG. 2, a block diagram illustrating an example, non-limiting embodiment of a system 200 for rating and weighting online content is shown. System 200 includes a content rating system 202 that collects votes from data store 210 and content rating portal 212 and produces a weighted rating of an item 214. Included in the content rating system 202 is a vote gathering component 204, a rating component 206 and a weighting component 208.

Vote gathering component 204 can be configured to collect votes from data store 210 and content rating portal 212. Vote gathering component 204 can collect votes from each source individually, or both together. Content rating portal 212 can be a website associated with the content rating system 202. Users reviewing and rating online content can enter their ratings, rankings, and/or reviews of online content into the content rating portal 212, and each submission can be counted by the vote gathering component as a vote. The votes can provide information about the voter, such as identity, background, voting history, as well as give a quantitative or qualitative rating of the online content. The quantitative rating can be a numerical value, such as a rating out of 10, or some other quantitative metric. A positive or negative rating, or a thumbs up/thumbs down rating can be examples of a qualitative rating.

Data store 210 can be any public or private pre-existing source of ratings for the online content. Data store 210 can be a database of reviews, or website containing ratings. Vote gathering component 204 can contain a list of sources of reviews and ratings and/or scour the Internet for other sources of reviews and ratings. Popular aggregator websites contain ratings for online content along with a information identifying the number of votes that make up the ratings.

Once vote gathering component 204 gathers the votes and ratings from content rating portal 212 and data store 210, rating component 206 can be configured to generate a rating based on the votes collected. The rating can be an average of each of the votes collected. In the case of numerical ratings received at a content rating portal 212, the averaged rating (Ra) can be expressed as:

$$Ra = \frac{\sum Ri}{Ni}$$

where Ri=Ratings received at content rating portal, Ni=Number of votes received at content rating portal.

When rating component 206 generates an average rating based on both votes received at a content rating portal 212 and from data store 210, the averaged rating can be expressed as:

$$Ra = \frac{Nk * Rk + \sum Ri}{N} ,$$

where Rk is the averaged rating in the data store 210, and Nk is the number of votes that Rk consists of, and N=(Nk+Ni). Thus, when rating component 206 generates the ratings based on the votes collected at the content rating portal 212 and from the data store 210, the two sets of votes are weighted such that they each give equal weighting on a per vote basis to the average rating. In other embodiments, the function that is used to generate the averaged rating can weight the content rating portal 212 votes higher than the data store 210 votes or vice versa.

With the average rating calculated by the rating component 206, weighting component 208 can be configured to generate a weighting coefficient that modifies the rating as a function of a number of votes collected. The weighting coefficient can be a multiplier that the weighting component 208 multiplies against the average rating to derive the weighted rating 214. The weighting coefficient W can be 0<W≦1, where the weighting coefficient is equal to one when there are a predetermined number of votes. The predetermined number of votes can be provided by the person viewing the ratings, or by the content rating system. The predetermined number of votes can also be determined based on the content being rated.

The weighting coefficient can then be a function of a base multiplier and the number of votes, where the base multiplier is the value of the weighting coefficient when the number of votes is zero. The base multiplier can be a predetermined number, and like the threshold number of votes can be based on the content being rated among other factors.

When the number of votes is low, the weighting coefficient reduces the average rating to account for the statistically insignificant number of votes. As the number of votes increase however, the weighting coefficient increases in value, approaching 1, so that the weighted rating is close to the average rating. When a threshold is passed, and the weighting coefficient is equal to 1, the weighted rating is equal to the average rating generated by the rating component 206. Votes collected beyond the threshold number of votes will serve to modify the average rating but not the weighting coefficient.

Rather than just modifying the rating based on the number of votes, other weighting systems are possible as well. For instance, in an embodiment of the present disclosure, weighting component 208 can be configured to hide, or not show, the ratings of items that do not meet a predetermined number of votes. Therefore, ratings that are statistically insignificant, can be prevented from being considered and/or shown. Rating component 206 can also be configured to not rate items until the predetermined number of votes have been received.

It is to be appreciated that while FIG. 2, and other FIGs disclosed and described herein, depict the ratings and weighted ratings as stars, or more specifically, as a number of stars out of 5 stars, other representations are possible. For instance, the rating and weighted ratings can based on a different number of stars, and/or other visual representations can be used to show the relative rankings of items. The ratings can also be presented numerically, and/or with non visual representations.

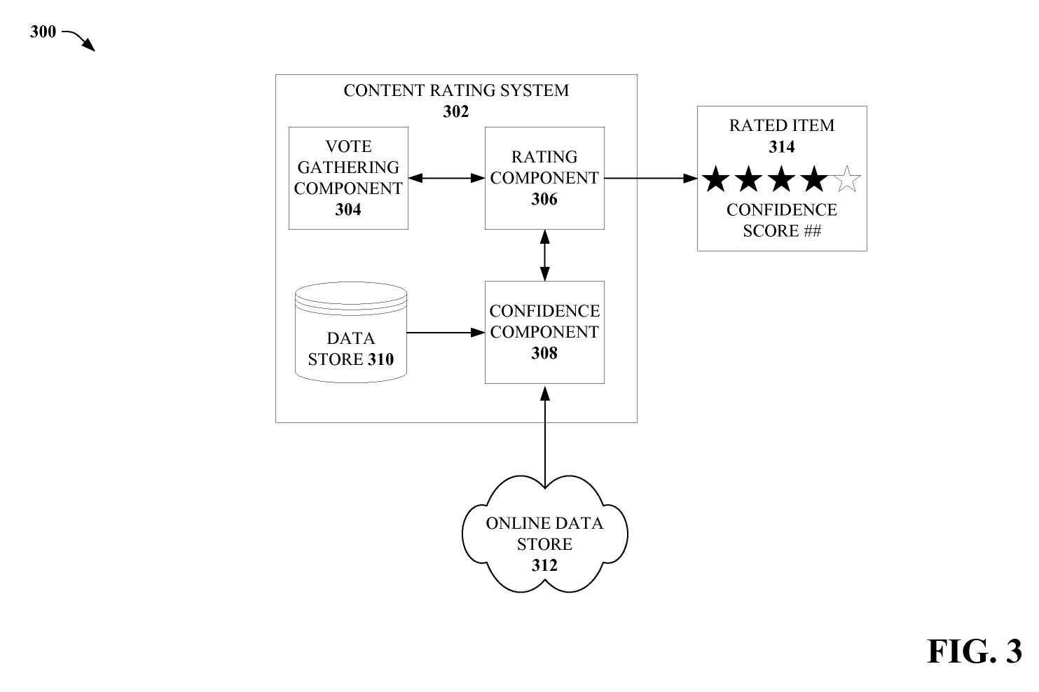

Turning now to FIG. 3, a block diagram illustrating an example, non-limiting embodiment of a system 300 for providing a confidence score for rated items is shown. System 300 includes a content rating system 302 that provides a rating and a confidence score for an item 314. Content rating system can include a vote gathering component 304, a rating component 306, a confidence component 308, and a data store 310 that stores context used to generate a confidence score. An online data store 312 that is separate from the content rating system 302 can also be used to store context that is used to generate a confidence score.

The vote gathering component 304 can be configured to collect votes that rating component 306 uses to generate the rating. Confidence component 308 can be configured to provide a confidence score of a rated item 314. The confidence score can provide a measure of the relative usefulness or reliability of the rating of the rated item. The confidence score can be based on the rated item, a number of votes gathered, an identity of the voter(s), a purchase history of the voter(s), and a voting history of the voter(s). The confidence score can also be based on similar information associated with the person viewing the rating.

Since the ratings can be made anonymously, the viewer of the rating does not always have the information available to judge the reliability of usefulness of the rating. If a majority, or a large number of people voting on an item have preferences that are different than the person viewing the rating, the ratings can even be misleading. The confidence score uses additional information to give the person viewing the rating an idea about how much confidence to place in the rating.

Confidence component 308 can retrieve information from data store 310 about the identity of the voters, person viewing the rating, purchase histories, voting histories, and other preferences and background information. The confidence component 308 can also retrieve information from online data store 312. The online data store 312 can be a public and/or private source of data that can be analyzed by the confidence component 308 to determine voter preferences, voter identification and so on.

In an embodiment, confidence component 308 can provide higher confidence scores to ratings that are made by voters known to the person viewing the rating. Votes by friends, family, and colleagues, can be given higher confidence scores. Similarly, votes by professionals, experts, and others in trusted positions can be given higher confidence scores.

In another embodiment, the confidence scores can be used by a weighting component (e.g., weighting component 208) to modify the ratings based on the confidence score. Ratings with higher confidence scores can be left as is, or boosted, whereas ratings with lower confidence scores can be decreased.

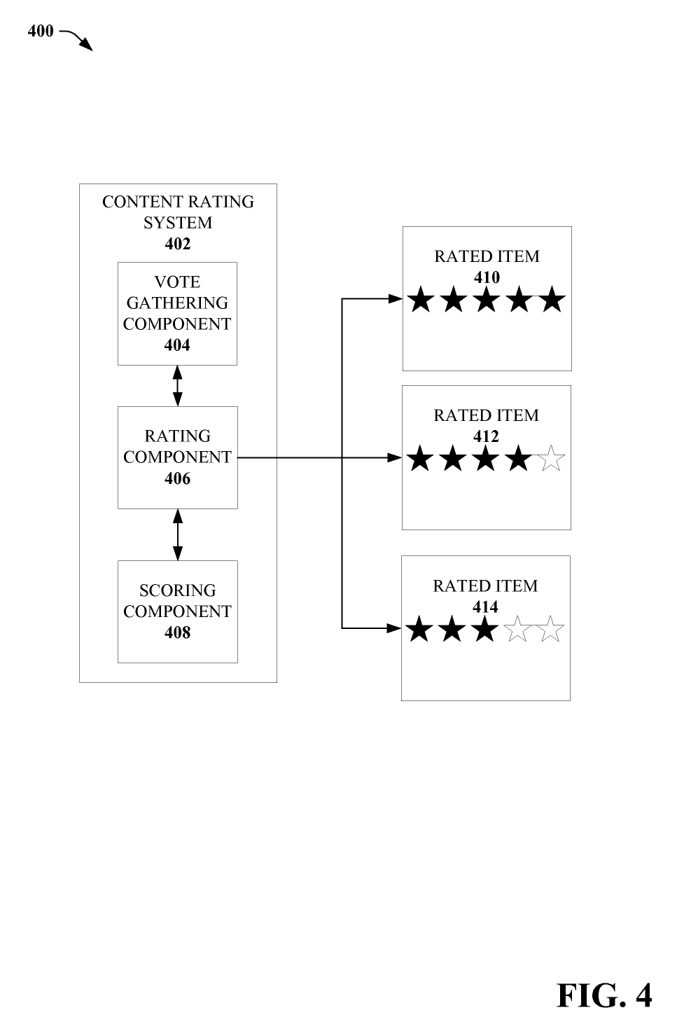

Referring now to FIG. 4, a block diagram illustrating an example, non-limiting embodiment of a system 400 for scoring rated items is shown. System 400 can include a content rating system 402 that generates scores for rated items 410, 412, and 414. The content rating system 402 can include a vote gathering component 404, a rating component 406, and a scoring component 408.

The vote gathering component 404 can be configured to collect votes which the rating component 406 uses to generate a rating of the items 410, 412, and 414. The rating can be weighted (e.g., by weighting component 208) and scoring component 408 can be configured to generate a score based on the weighted rating, where the score is a measure of the relative ratings of items.

In some embodiments, the rating generated by the rating component 406 can be a raw numerical rating that is difficult to intuitively grasp. The scoring component 408 can interpret the rating, and provide a score that is easy to understand. The score can be a percentile rank of the relative ranking of the items 410, 412, and 414. The score can also be translated into a visual medium. For instance in FIG. 4, the ratings of items 410, 412, and 414 have been translated into a number of stars out of 5 stars. So for example, rated item 410 has been scored at 5 stars out of 5, rated item 412 has been scored at 4 stars out of 5, and rated item 414 has been scored at 3 stars out of 5. In other embodiments, scoring component 408 can generate scores using other visual representations and techniques.

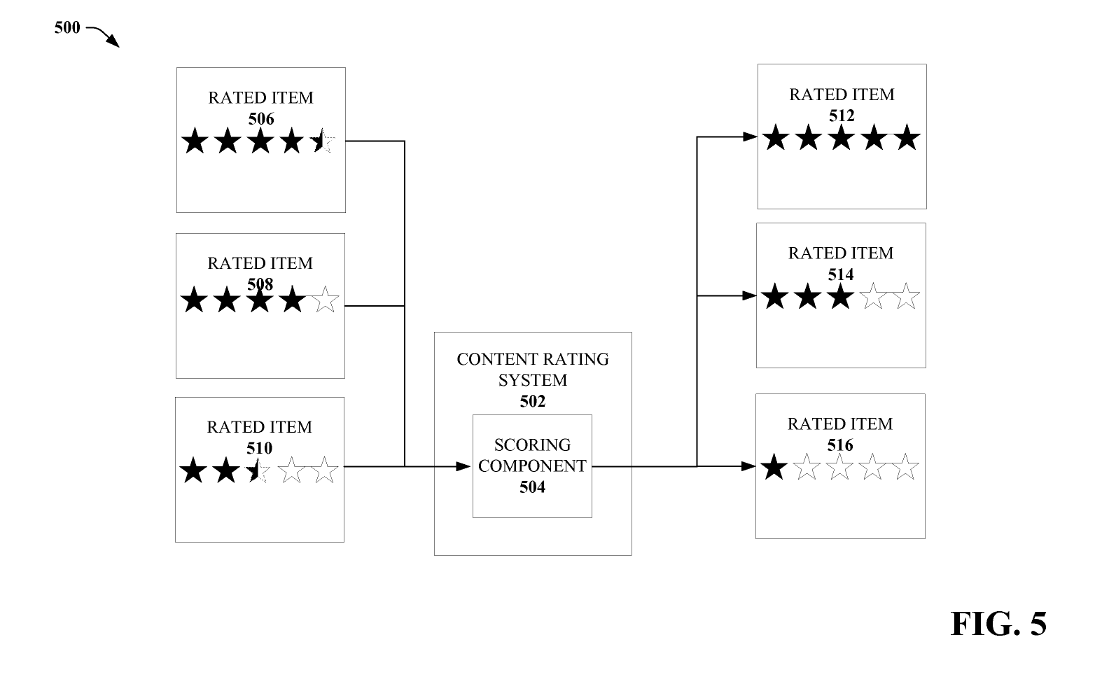

Turning now to FIG. 5, a block diagram illustrating an example, non-limiting embodiment of a system 500 for scoring rated items is shown. System 500 includes a content rating system 502 and a scoring component 508 that translates scores 506, 508, and 510 into modified scores 512, 514, and 516 respectively.

Scores that are close together, such as scores 506, 508, and 510, respectively, 4.5 stars out of 5, 4 stars out of 5, and 3.5 stars out of 5, can be modified to make it easier to visualize the relative spread of ratings and scores. The modified scores, 5 out of 5 stars for item 512, 3 out of 5 stars for item 514, and 1 star out of 5 for item 516 make it easier to see the gaps between the ratings.

Scoring component 508 can generate the modified scores based on a spread of ratings of similar items. For instance, if a large number of rated items that are similar to each other (such as movies) all have raw and/or weighted ratings and scores that are very close together, it can be difficult to determine the relative rankings of the items. Scoring component can then assign different scores to more clearly show the relative ratings of the items.

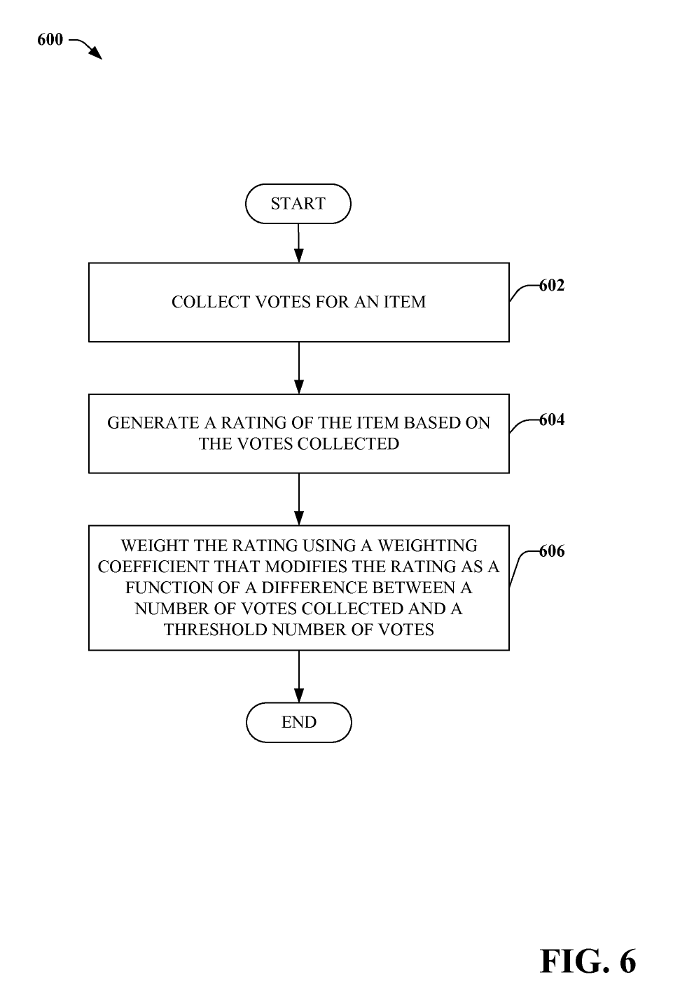

FIGS. 6-8 illustrates processes in connection with the aforementioned systems. The processes in FIGS. 6-8 can be implemented for example by systems 100-500 illustrated in FIGS. 1-5 respectively. Additionally, it should be appreciated that the methods disclosed in this specification are capable of being stored as computer-executable instructions on a non-transitory computer readable medium that in response to execution, cause a system including at least one processor to perform operations in accordance with the methods.

FIG. 6 illustrates a flow diagram of an example, non-limiting embodiment of a method 600 for rating and weighting online content in accordance with the present disclosure. At 602, votes are collected for an item, and at 604 a rating of the item is generated based on the votes collected. At 606, the rating is weighted using a weighting coefficient that modifies the rating as a function of a difference between a number of votes collected and a threshold number of votes.

At 602, the votes can be collected by a content rating portal, or from online data stores. The content rating portal can be a website associated with a content rating system. Users reviewing and rating online content can enter their ratings, rankings, and/or reviews of online content into the content rating portal and each submission can be counted as a vote. The votes can provide information about the voter, such as identity, background, voting history, as well as give a quantitative or qualitative rating of the online content. The online data stores can be any public or private pre-existing source of ratings for the online content. Popular aggregator websites contain ratings for online content along with a information identifying the number of votes that make up the ratings.

At 604, once the votes are collected, a rating of the item and/or online content can be generated based on the votes collected. The rating can be an average of each of the votes collected. In the case of numerical ratings received at a content rating portal, the averaged rating (Ra) can be expressed as:

$$Ra = \frac{\sum Ri}{Ni}$$

where Ri=Ratings received at content rating portal, Ni=Number of votes received at content rating portal.

When average ratings are based on both votes received at a content rating portal and from an online data store, the averaged rating can be expressed as:

$$Ra = \frac{Nk * Rk + \sum Ri}{N} ,$$

where Rk is the averaged rating in the online data store, and Nk is the number of votes that Rk consists of, and N=(Nk+Ni). Thus, the ratings are generated and weighted such that they each give equal weighting on a per vote basis to the average rating. In other embodiments, the function that is used to generate the averaged rating can weight the content rating portal votes higher than the online data store votes or vice versa.

At 606, the average rating is weighted using a weighting coefficient that modifies the rating as a function of a difference between a number of votes collected and a predetermined number of votes. The weighting coefficient can be multiplied against the average rating to derive the weighted rating. The weighting coefficient W can be 0<W≦1, where the weighting coefficient is equal to one when there are a predetermined number of votes. The predetermined number of votes can be provided by the person viewing the ratings, or by the content rating system. The predetermined number of votes can also be determined based on the content being rated.

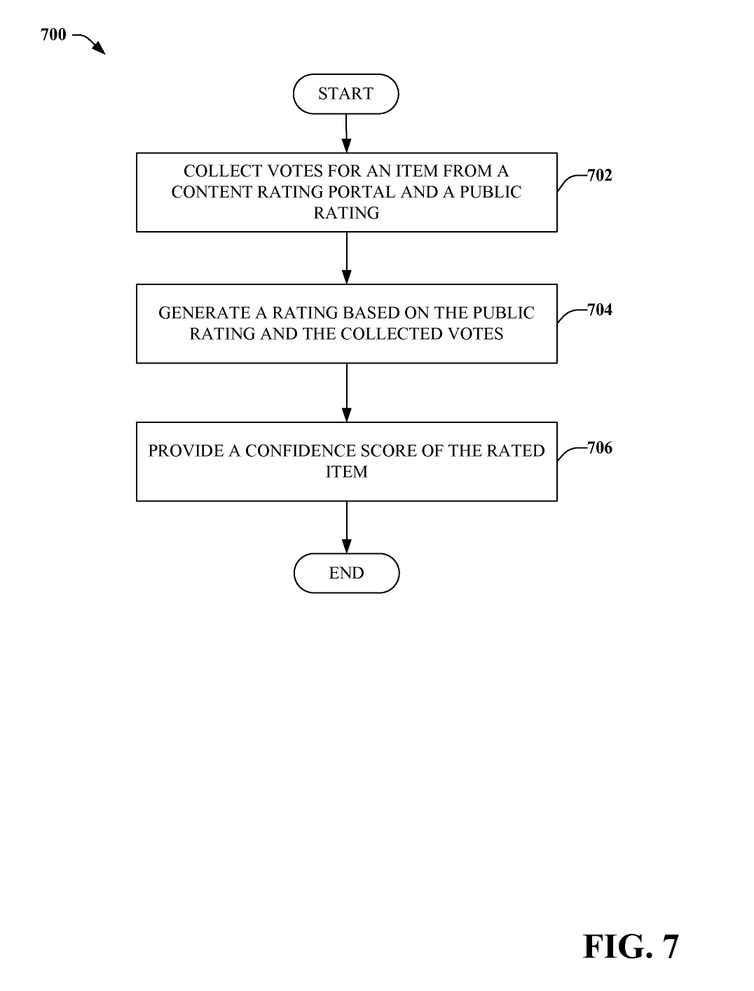

Turning now to FIG. 7, a flow diagram of an example, non-limiting embodiment of a method 700 for providing a confidence score for rated items is shown. At 702, votes are collected for an item from an content rating portal and votes associated with a public rating. At 704, the rating is generated based on the public rating and the collected votes, and at 706, a confidence score of the rated item is provided.

The content rating portal can be a website associated with a content rating system. Users reviewing and rating online content can enter their ratings, rankings, and/or reviews of online content into the content rating portal and each submission can be counted as a vote. The votes can provide information about the voter, such as identity, background, voting history, purchase history and other preferences associated with the voter.

At 704, the rating of the item and/or online content can be generated based on the votes collected. The rating can be an average of each of the votes collected and weighted such that the votes from the content rating portal and the public rating are weighted equally on a per vote basis. The function for generating the rating can also preferentially treat votes from either the content rating portal or the public rating.

At 706, the confidence score of the rated item can be provided to give a better idea of the reliability of the rating. The confidence score can be based on the rated item, a number of votes gathered, an identity of the voter(s), a purchase history of the voter(s), and a voting history of the voter(s). The confidence score can also be based on similar information associated with the person viewing the rating.

Since the ratings can be made anonymously, the viewer of the rating does not always have the information available to judge the reliability of usefulness of the rating. If a majority, or a large number of people voting on an item have preferences that are different than the person viewing the rating, the ratings can even be misleading. The confidence score uses additional information to give the person viewing the rating an idea about how much confidence to place in the rating.

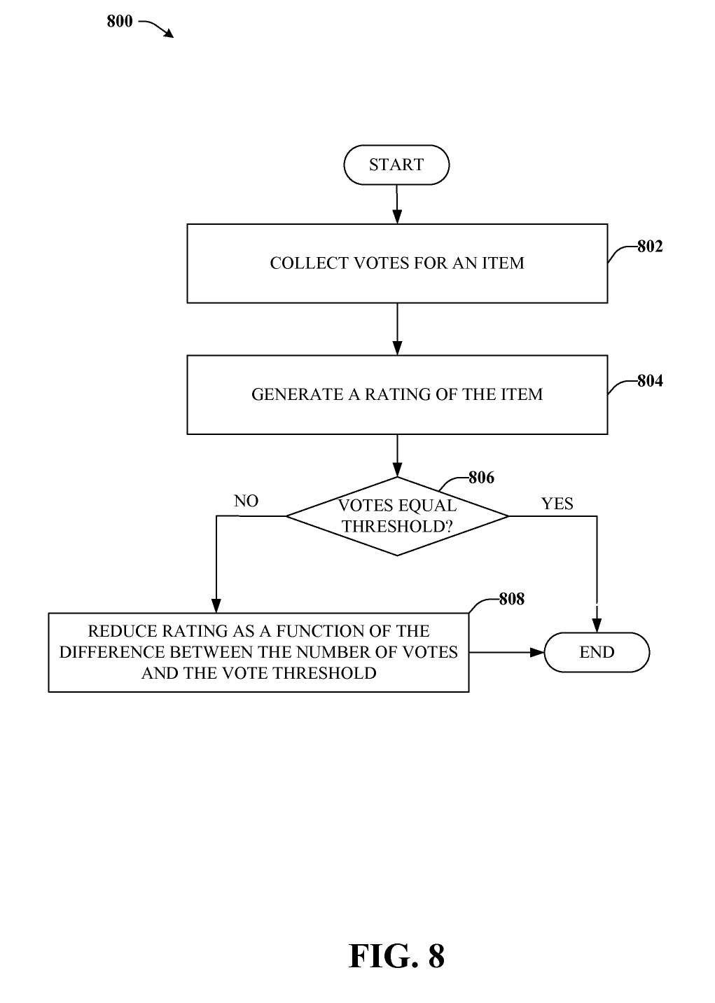

Turning now to FIG. 8, a flow diagram of an example, non-limiting embodiment of a method 800 for weighting ratings that do not meet a threshold number of votes is shown. At 802, votes are collected for an item. At 804, a rating is generated for the item based on the votes collected. The rating can be an average rating that takes into consideration each vote for an item equally, from wherever the vote is obtained.

At 806, a determination is made about whether or not the number of votes that make up the rating equals a predetermined threshold of number of votes. If the number of votes is below the threshold, the rating is reduced as a function of the difference between the number of votes actually collected and the threshold number of votes. As the difference gets smaller, and the number of votes collected increases, the rating can be reduced by a smaller amount. On the other hand, if the number of votes collected exceeds the threshold, no change to the rating is made.

There can be a base weighting coefficient that is used, so that even if there is only 1 vote for an item, the base weighting coefficient is used. For instance, the base weighting coefficient can be 0.5, or anything other predetermined number between 0 and 1. As the number of votes increase, the weighting coefficient that is multiplied against the rating approaches 1.

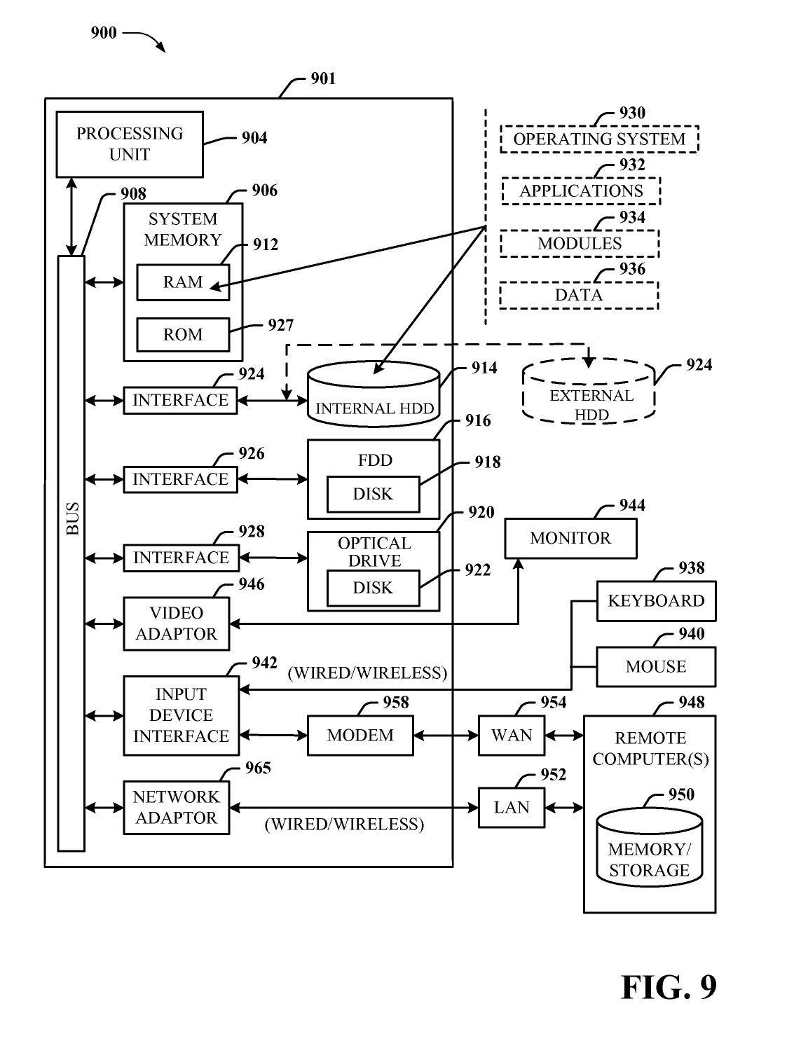

With reference to FIG. 9, an exemplary environment 900 for implementing various aspects described herein includes a computer 902, the computer 902 including a processing unit 904, a system memory 906 and a system bus 908. The system bus 908 connects system components including, but not limited to, the system memory 906 to the processing unit 904. The processing unit 904 can be any of various commercially available processors. Dual microprocessors and other multi processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 911 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that aspects of the subject disclosure can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 can operate in a networked environment using logical connections by wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or can be connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

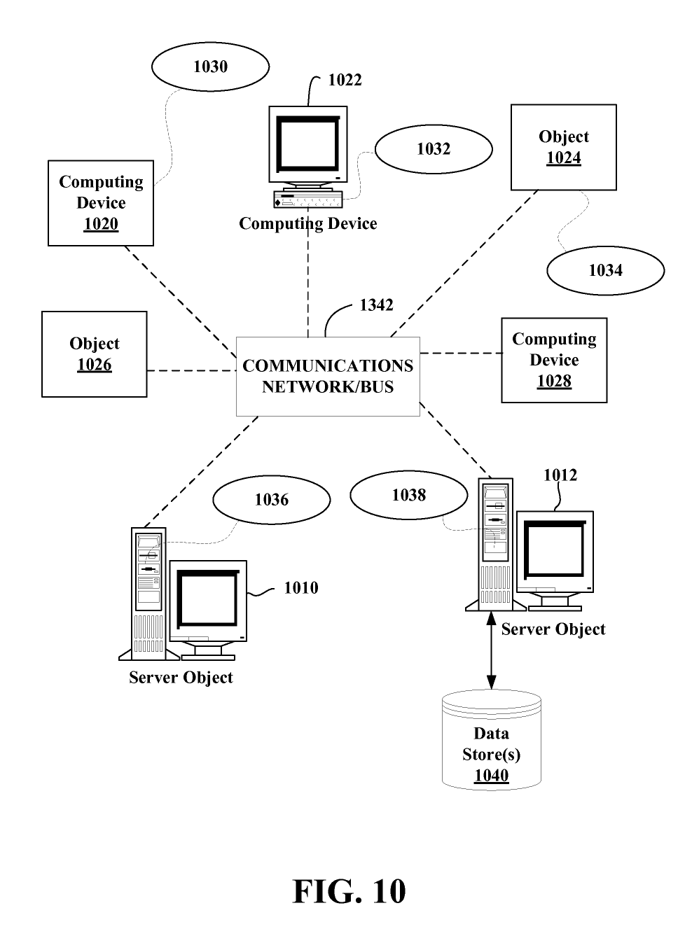

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, including multimedia display device 100 or similar devices depicted within the illustrations, or other devices such as a mobile phone, personal digital assistant (PDA), audio/video device, MP3 players, personal computer, laptop, etc. It should be further appreciated that data store(s) 1040 can include data store 108, or other similar data stores disclosed herein.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques for rating and weighting the ratings of online content in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for rating and weighting the ratings of online content as described in various embodiments herein.

Thus, a host of network topologies and network infrastructures, such as client/server, peer-to-peer, or hybrid architectures, can be utilized. One or more of these network topologies can be employed by network-enabled television 104, 200, 302, 600 for communicating with a network. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A content rating system, comprising:
a memory storing computer-executable components; and
a processor, communicatively coupled to the memory, which executes, or facilitates execution of, one or more of the computer-executable components, the computer-executable components, comprising:
a vote gathering component configured to collect votes;
a rating component configured to generate a rating based on the votes collected; and
a weighting component configured to generate a weighting coefficient that modifies the rating as a function of a difference between a number of votes collected and a threshold number of votes.

2. The system of claim 1, wherein the votes are collected via a content rating portal.

3. The system of claim 1, wherein the vote gathering component is further configured to collect a public rating, wherein the public rating includes information identifying a number of votes associated with the public rating.

4. The system of claim 3, wherein the rating component is further configured to generate the rating based on the public rating and the collected votes.

5. The system of claim 1, wherein the weighting coefficient is a function of the number of votes collected at the content rating portal and a number of votes associated with a public rating.

6. The system of claim 1, wherein the weighting coefficient reduces the rating when the number of votes is below the threshold number of votes.

7. The system of claim 1, wherein the weighting coefficient is a multiplier that approaches 1 as the number of votes increases.

8. The system of claim 1, wherein the weighting coefficient has a predetermined base multiplier.

9. The system of claim 1, wherein the computer-executable components further comprise:
a confidence component configured to provide a confidence score of a rated item.

10. The system of claim 9, wherein the confidence score is based on the rated item, a number of votes gathered, an identity of a voter, a purchase history of the voter, or a voting history of the voter.

11. The system of claim 1, wherein a weighting coefficient function is based on an item being voted on.

12. The system of claim 1, wherein the computer-executable components further comprise:
a scoring component configured to generate a score based on the weighted rating, wherein the score is a measure of relative ratings of items.

13. The system of claim 12, wherein the scoring component generates a score based on a spread of ratings of similar items.

14. A method, comprising:
collecting, by a system including at least one processor, votes for an item;
generating, by the system, a rating of the item based on the votes collected; and
weighting, by the system, the rating using a weighting coefficient that modifies the rating as a function of a difference between a number of votes collected and a threshold number of votes.

15. The method of claim 14, further comprising collecting, by the system, the votes via a content rating portal.

16. The method of claim 14, further comprising collecting, by the system, a public rating that includes information identifying a number of votes associated with the public rating.

17. The method of claim 16, further comprising, generating, by the system, the rating based on the public rating and the collected votes.

18. The method of claim 14, wherein the weighting is based on the number of votes collected and a number of votes associated with a public rating.

19. The method of claim 14, wherein the weighting reduces the rating of the item when the number of votes collected is below the threshold number of votes.

20. The method of claim 14, wherein the weighting further comprises applying a multiplier that approaches 1 as the number of votes increases.

21. The method of claim 14, further comprising providing, by the system, a confidence score of a rated item based on a number of votes gathered, an identity of a voter, a purchase history of the voter, or a voting history of the voter.

22. The method of claim 14, wherein the weighting the rating is based on the item being voted on.

23. The method of claim 14, further comprising generating, by the system, a score based on the weighted rating, wherein the score is a measure of relative rankings of similar items.

24. The method of claim 23, wherein the generating the score further comprises generating a score, by the system, based on a spread of weighted rankings of the similar items.

25. A non-transitory computer-readable storage device comprising computer-executable instructions that, in response to execution, cause a system including at least one processor to perform operations, comprising:
collecting votes for an item;
generating a rating of the item based on the votes collected; and
weighting the rating using a weighting coefficient that modifies the rating as a function of a difference between a number of votes collected and a predetermined number of votes.
